(19) United States
(12) Patent Application Publication
(10) Pub. No.: US 2009/0051647 A1
(43) Pub. Date: Feb. 26, 2009

(54) PORTABLE ELECTRONIC DEVICE WITH MOTION SENSING MODULE

(75) Inventors: CHIH-CHUNG SU, Tu-Cheng (TW); SHIH-HSIN HUANG, Tu-Cheng (TW); HSIN-CHIEH YEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/961,262

(22) Filed: Dec. 20, 2007

(30) Foreign Application Priority Data
Aug. 24, 2007 (CN) 200710201454.5

(51) Int. Cl. G09G 5/00

(52) U.S. Cl. 345/156

(57) ABSTRACT

A portable electronic device includes a display module for displaying a menu, a motion sensing module, and a controlling module. The menu having a plurality of menu options. The motion sensing module detects a motion of the portable electronic device imparted by a user and generates a trigger signal associated with the motion of the portable electronic device. The controlling module controls choosing and/or executing a menu option in response to the trigger signal.

### BACKGROUND

1. Field of the Invention

The present invention relates to a portable electronic device with motion sensing module.

2. Description of Related Art

Portable electronic devices of small size are popular with people. Generally, portable electronic devices include controls such as keys, buttons, and dials for people to operate the portable electronic devices. However, though functional, the ever smaller controls developed for smaller and smaller electronic devices have become inconvenient for people to use. Moreover, if people (users) operate the portable electronic device repeatedly over a long period of time, they may develop health problems such pain in their finger joints.

What is needed, therefore, is to provided a portable electronic device, in which the above problems are eliminated or at least alleviated.

### SUMMARY

The present invention relates to a portable electronic device. The portable electronic device includes a display module for displaying a menu, a motion sensing module, and a controlling module. The menu having a plurality of menu options. The motion sensing module detects a motion of the portable electronic device imparted by a user and generates a trigger signal associated with the motion of the portable electronic device. The controlling module controls choosing and/or executing a menu option in response to the trigger signal.

Other advantages and novel features of the present invention will become more apparent from the following detailed description of present embodiments when taken in conjunction with the accompanying drawings, in which:

### BRIEF DESCRIPTION OF THE DRAWINGS

FIG. 1 shows functional modules of a portable electronic device according to a present embodiment;

FIG. 2 shows a first motion of the portable electronic device according to the present embodiment;

FIG. 3 is similar to FIG. 2, but showing a second motion of the portable electronic device;

FIG. 4 is similar to FIG. 3, but showing a third motion of the portable electronic device;

FIG. 5 is similar to FIG. 4, but showing a fourth motion of the portable electronic device; and

FIG. 6 is similar to FIG. 5, but showing a fifth motion of the portable electronic device.

### DETAILED DESCRIPTION OF THE INVENTION

Reference will now be made to the drawing figures to describe the at least one present embodiment in detail.

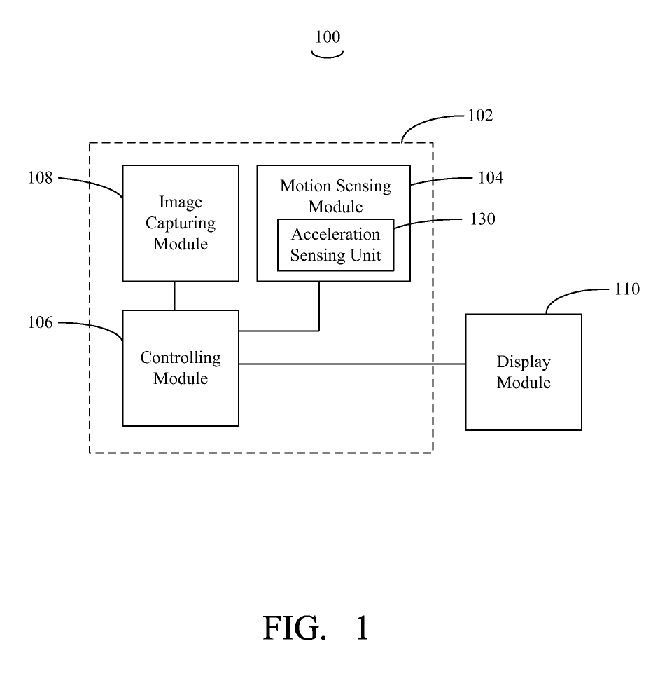

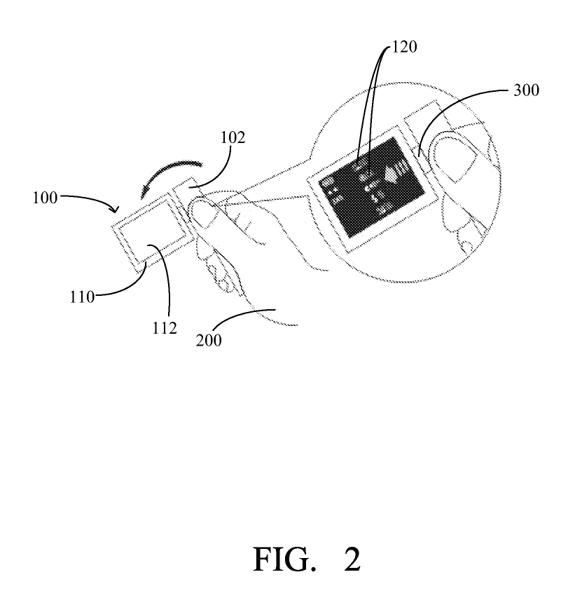

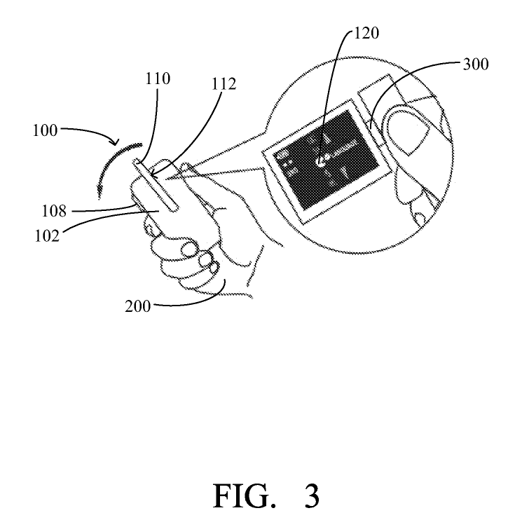

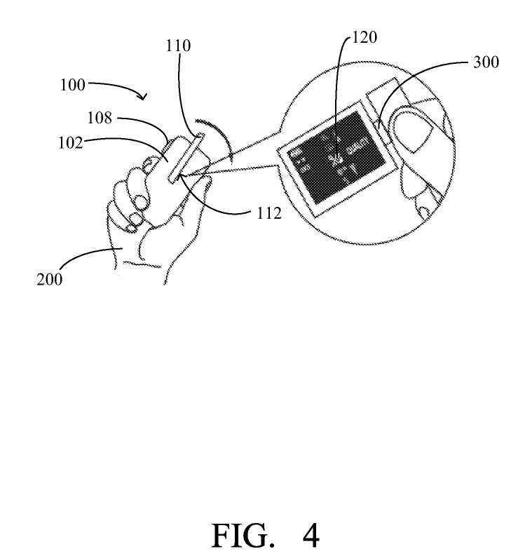

Referring to FIGS. 1-2, a portable electronic device 100, according to a present embodiment, is shown. As an example, the portable electronic device 100 is a digital still camera. The portable electronic device 100 includes a body 102, a motion sensing module 104, a controlling module 106, an image capturing module 108 (shown in FIGS. 3 and 4), and a display module 110 rotatably connected to the body 102 by a hinge structure 300. It is to be understood that the image capturing module 108 generally includes a lens module (not shown), and an image sensor (not shown) such as a CCD or a CMOS. Alternatively, the display module 110 may be attached to a surface of the body 102 or embedded in the surface of the body 102.

The body 102 can be held in a user's hand 200 as shown in FIGS. 2 to 6. The motion sensing module 104 is configured for detecting a motion (hereafter referred to as a target motion) of the body 102 imparted by the user's hand 200, and generating a trigger signal associated with the motion of the body 102 of the portable electronic device 100. The motion sensing module 104 includes an acceleration sensing unit 130, for example, a three-axis micro-electro-mechanical-system acceleration sensing unit. In detail, the motion sensing module 104 detects acceleration and a direction of the target motion of the body 102. If the acceleration and the direction of the target motion are in a pre-determined response range of the motion sensing module 104, the motion sensing module 104 generates a trigger signal to the controlling module 106 associated with the target motion. Setting of the pre-determined response range of the motion sensing module 104 is based on sensitivity of the acceleration sensing unit 130. Alternatively, the motion sensing module 104 may include a gyroscope sensing unit.

The display module 110 includes a display screen 112 for displaying a main menu and the menu options. Images immediately captured by the image capturing module 108 and parameters such as remaining power of the battery, date, etc., are shown on the display screen 112. The controlling module 106 receives the trigger signal, and controls choosing and/or executing a menu option in response to the trigger signal.

An operation of the portable electronic device 100 of the present embodiment is described in detail as follows.

A trigger signal corresponding to a motion of the body 102 to show a pre-determined main menu is pre-set in the motion sensing module 104 of the portable electronic device 100. The main menu includes a plurality of sub-menus, and each sub-menu includes a plurality of menu options.

When the motion sensing module 104 detects a left motion (hereafter referred to as a first target motion) of the body 102, a first trigger signal causes the main menu to be displayed in the display screen 112. The “left” direction is a left-hand direction of the user 200.

When the motion sensing module 104 detects a backward motion (hereafter referred to as a second target motion) of the body 102, a second trigger signal causes a selection indicator (e.g. cursor, highlighting, or in this embodiment, magnification of current selection in the display screen 112) to browse the sub-menus 120 from bottom to top in the display screen 112, that is each second trigger signal causes the selection indicator to move to the sub-menu 120 above its present location (or return to bottom sub-menu if selection indicator is at the topmost sub-menu). The “backward” direction is a direction getting closer to the user 200.

When the motion sensing module 104 detects a forward motion (hereafter referred to as a third target motion) of the body 102, a third trigger signal causes the selection indicator (e.g. cursor, highlighting, or in this embodiment, magnification of current selection in the display screen 112) to browse the sub-menus 120 from top to bottom in the display screen 112, that is each third trigger signal causes the selection indicator to move to the sub-menu 120 above its present location (or return to top sub-menu if selection indicator is at the bottommost sub-menu). The “forward” direction is a direction getting far from to the user 200.

When the motion sensing module 104 detects a right motion (hereafter referred to as a fourth target motion) of the body 102, a fourth trigger signal is initiated to choose a sub-menu and enter the sub-menu to show the plurality of menu options on the display screen 112. The “right” direction is a right-hand direction of the user 200.

While in the selected sub-menu an additional right motion (hereafter referred to as a fifth target motion) of the body 102, triggers a fifth trigger signal to execute a function corresponding to the menu option.

Moreover, rules are pre-set in the motion sensing module 104 of the portable electronic device 100: at a same-level menu, if the motion sensing module 104 doesn't detect the fifth target motion of the body 102 first, but instead detects a left motion (hereafter a sixth target motion) of the body 102, a sixth trigger signal is initiated to return selection to a menu one level up, i.e., the menu options returned to the upper-level sub-menus; if the motion sensing module 104 has already detected the fifth target motion of the body 102, and then the motion sensing module 104 detects a right motion (hereafter referred same as the sixth target motion) of the body 102, a seventh trigger signal is initiated to return to upper-level menus.

Referring to FIGS. 1 and 2 again, firstly, the portable electronic device is turned on. Parameters of the portable electronic device 100, such as remaining power of the battery, a current scene mode, taking an “indoor” mode as an example, a current resolution of an image, etc. are shown on the display screen 112 of the display module 110.

If the user 200 wants to change the “indoor” mode to an “outdoor” mode for example, the user 200 holds the body 102, and swings the body 102 to the left, i.e., the first target motion of the body 102, the motion sensing module 104 determines whether the acceleration and the direction of the first target motion of the body 102 are in the pre-determined response range of the motion sensing module 104. If yes, the motion sensing module 104 generates the first trigger signal to the controlling module 106 associated with the first target motion; if no, the motion sensing module 104 doesn't output any trigger signal to the controlling module 106. In this way, an unexpected swing of the user 200 leading to an unexpected operation of the portable electronic device can be avoided. Further, for convenient description, the following acceleration and the direction of the target motion are in the pre-determined response range of the motion sensing module 104.

The controlling module 106 receives the first trigger signal, and show a plurality of per-determined sub-menus 120, e.g., language, scene mode, setting, date, etc. on the display screen 112. In this present embodiment, the sub-menus 120 are shown in a list form.

Referring to FIGS. 1, 3 and 4, the user 200 swings the body 102 backwards, i.e., the second target motion of the body 102/forwards, i.e., the third target motion of the body 102, the motion sensing module 104 generates the second/third trigger signal to the controlling module 106 associated with the second/third target motion. The controlling module 106 receives the second/third trigger signal, and causes the selection indicator to browse the sub-menus 120 upwards/downwards to the “scene mode” sub-menu 120.

The user 200 swings the body 102 to the right, i.e., the fourth target motion of the body 102, the motion sensing module 104 generates the fourth trigger signal to the controlling module 106 associated with the fourth target motion. The controlling module 106 receives the fourth trigger signal, and shows a plurality of menu options, e.g., “indoor”, “outdoor”, “snow”, “macro”, etc. in the “scene mode” menu 120. The plurality of menu options are arranged in a list form.

The user 200 swings the body 102 backwards, i.e., the second target motion of the body 102)/forwards, i.e., the third target motion of the body 102, the motion sensing module 104 generates the second/third trigger signal to the controlling module 106 associated with the second/third target motion. The controlling module 106 receives the second/third trigger signal, and causes the selection indicator to browse the menu options upwards/downwards to the “outdoor” menu option. The user 200 swings the body 102 to the right, i.e., the fifth target motion of the body 102. The motion sensing module 104 generates the fifth trigger signal to the controlling module 106 associated with the fifth target motion. The controlling module 106 receives the fifth trigger signal, and executes a function corresponding to the “outdoor” menu option. By doing so, the scene mode is changed from “indoor” to “outdoor”.

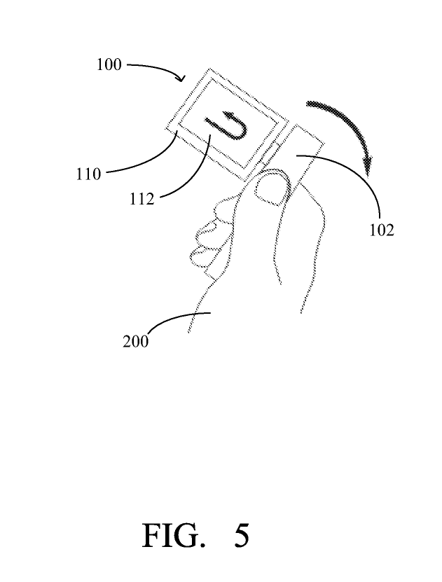

Referring to FIG. 5, after the scene mode is changed, the user 200 swings the body 102 to the right, i.e., the sixth target motion of the body 102. The motion sensing module 104 generates the seven trigger signal to the controlling module 106 in response the sixth target motion. The controlling module 106 shows the plurality of sub-menus 120, i.e., the menu options returned to the upper-level sub-menus.

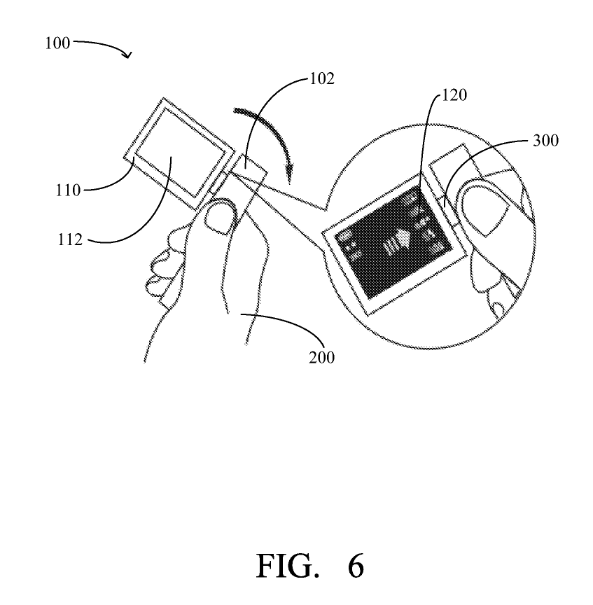

Referring to FIG. 6, the user 200 swing the body 102 to the right, i.e., the sixth target motion of the body 102 again so that the controlling module 106 hides the plurality of the sub-menus 120.

Since a motion of the portable electronic device 100 is detected by the motion sensing module 104 mounted in the portable electronic device 100 to show menus and execute functions corresponding to the menus, manual controls may be omitted from the portable electronic device 100 to further minimize a size of the portable electronic device 100 to enhance portability of the electronic device. Moreover, even if the user 200 operates the portable electronic device for a long time, the user doesn't feel painful either.

In addition, a pre-determination of the motion corresponding to a trigger signal and rules pre-set in the controlling module 106 are determined by manufacturers, and are not limited to the above description.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device, comprising:
a display module for displaying a menu, the menu having a plurality of menu options;
a motion sensing module for detecting a motion of the portable electronic device imparted by a user and generating a trigger signal associated with the motion of the portable electronic device; and
a controlling module for controlling choosing and/or executing a menu option in response to the trigger signal.

2. The portable electronic device as claimed in claim 1, wherein the motion sensing module comprises an acceleration sensing unit or a gyroscope sensing unit.

3. The portable electronic device as claimed in claim 1, wherein the display module comprises a display screen for displaying the menu and the menu options.

4. The portable electronic device as claimed in claim 1, further comprising a body, wherein the motion sensing module is mounted in the body and the display module is rotatably connected to the body by a hinge structure.

5. The portable electronic device as claimed in claim 1, further comprising an image capturing module for capturing images.
